(19) United States
(12) Patent Application Publication
(10) Pub. No.: US 2004/0148783 A1
(43) Pub. Date: Aug. 5, 2004

(54) Lawn trimmer guard

(76) Inventors: Keith C. Cashman, Gardners, PA (US); Terry Van Metre, Biglerville, PA (US)

Correspondence Address: Marc J. Farrell, Reed Smith LLP, 213 Market Street, 9th Floor, P.O. Box 11844, Harrisburg, PA, 17108-1844, US

(21) Appl. No.: 10/630,334

(22) Filed: Jul. 29, 2003

Related U.S. Application Data
(60) Provisional application No. 60/399,204, filed on Jul. 29, 2002.

(51) Int. Cl. B26B 7/00

(52) U.S. Cl. 30/276

(57) ABSTRACT

An improved guard is provided for flexible cutting element devices such as lawn trimmers. The guard extends above the cutting planed formed by the circular travel of the flexible cutting element. The flexible cutting element is allowed to extend past the perimeter of the guard, such that the cutting action created by the travel of the cutting element occurs immediately past the edge of the guard. A cutter may be provided outside of the perimeter of the guard and extending into the plane formed by the rotation of the cutting element to function as a cutter for setting the length of a cutting element being used. The guard may be formed as a single piece or as a composite which when assembled encircles the center assembly of the cutting device.

### RELATED APPLICATIONS

The present application claims priority to U.S. Provisional Patent Application Serial No. 60/399,204, filed on Jul. 29, 2002.

### FIELD OF THE INVENTION

The present invention relates to lawn trimmers, and more particularly to trimmer guards that may be used to shield a user of a lawn trimmer from a portion of the trimming element when the trimmer is in use.

### BACKGROUND OF THE INVENTION

Powered weed and grass trimmers, which have rotating cutting elements, are commonly used to edge lawns and cut vegetation in hard-to-reach places that conventional lawnmowers cannot reach. The cutting elements are typically flexible members to reduce the momentum of the cutting element, such that contact between the cutting element and an object such as a fence or tree does not cause damage to the object. While powered trimmers are useful for applications such as cutting grass close to tree trunks and flower beds, they have numerous disadvantages relating to the configuration of the cutting blade and a typical guard housing.

Typically, the cutting filament or blade of the string trimmer rotates in a planar cutting circle. As shown in FIG. 1, the rotating force for the filament may be provided by a gasoline engine or electrical motor located at one end of a shaft, with the rotating filament located at an opposite end. A guard housing is typically provided to form a shield between an operator of the device and any debris which may be expelled by the cutting action of the trimmer element. Such guard housings do not enshroud the entire cutting plane of the trimmer, since this would prevent the trimmer element from contacting the material to be cut. Typically, the guard housings extend approximately one-fourth to one-half the circumference of the planar cutting circle, and are oriented around the rearward periphery of the cutting circle. The cutting string or blade is thus exposed in the forward regions of the cutting circle, which can be dangerous and can cause inadvertent injury to operators and bystanders by launching cut debris upward in the forward, unshrouded, portion of the cutting circle.

One disadvantage of having the forward periphery of the cutting circle exposed is that damage readily occurs to large portions of the cutting filament or blade when it inadvertently contacts a hard object such as a tree or sidewalk. The trimmer head may be forced into contact with the object such that the mid portion of the cutting element contacts the object, rather then just the end of the cutting element. In addition to the damage caused by uncontrollably launching large broken portions of filament or blades, broken exposed filament and blades require the operator to more frequently pay out additional cutting filament or to frequently sharpen or replace blades.

A second disadvantage arises in that the mid-span of the cutting element may become the surface of the cutting element which comes into contact with objects such as grass or weeds that are to be cut. Due to the rotating motion of the cutting element, the ends of the cutting elements have the greatest velocity, and accordingly the greatest cutting action. When objects impinge against the mid span of the cutting element, the velocity of the cutting element is lower, reducing the effectiveness of the cutting action. Furthermore, due to the shorter moment arm about the axis of rotation, greater torque is required to force the cutting element through the object.

### SUMMARY OF THE INVENTION

The present invention provides an improved guard for a conventional lawn trimmer, typically having a string-type cutting blade that rotates in a planar cutting circle. The guard is removeably and adjustably attached to the trimmer shaft using any of several attachment means, including but not limited to bolts, screws, brackets, clamps, and the like. The point of guard attachment to the shaft is located above the trimmer head so that the guard lies between the trimmer head and the operator controls.

The guard is preferably semi-spherical or circular, and in any embodiment extends a full 360 degrees around and above the periphery of the cutting circle formed by the cutting filament or blade. In the preferred embodiment, the guard occupies a reasonably uniform arc about the: cutting blade's axis of rotation, and its lower edge is approximately coplanar with the blade's cutting circle. The guard may be fabricated from any suitable durable and rigid material, including but not limited to metal or plastic.

### BRIEF DESCRIPTION OF THE DRAWINGS

FIG. 1 shows a side view of a generic lawn trimmer incorporating a guard according to the present invention.

FIG. 2 shows a side view in cross-section of a lawn trimmer guard according to the present invention, wherein the guard is mounted to a trimmer via a mounting flange.

FIG. 3 shows an illustrative view of the guard of FIG. 2.

FIG. 4 shows an illustrative view of a guard according to the present invention, utilizing two guard halves which may be attached around a trimmer shaft to retain the guard to the trimmer.

### DETAILED DESCRIPTION OF THE INVENTION

In the Figures, wherein like reference numerals identify like elements, there is shown a lawn trimmer guard 100 according to the present invention attached to a generic lawn trimmer 102. The lawn trimmer 102 typically will include a gas or electric motor 104 for providing rotational motion to at least one cutting element 106. The cutting element 106 may be a string or monofilament line, a metal wire or chain, a solid metal blade, or a plastic cutting piece. Typically, however, the cutting element 106 will be a monofilament line that is paid out from center assembly 108. The gas or electric motor 104 may be connected to center assembly 108 by a shaft 110 containing a drive element (not shown) for transferring rotational motion from the gas or electric engine 104 to the cutting element or elements. A throttle grip 112 or other handhold may be provided adjacent the gas or electric motor to allow a user to drip the lawn trimmer. A handle 114 may additionally be provided for the user.

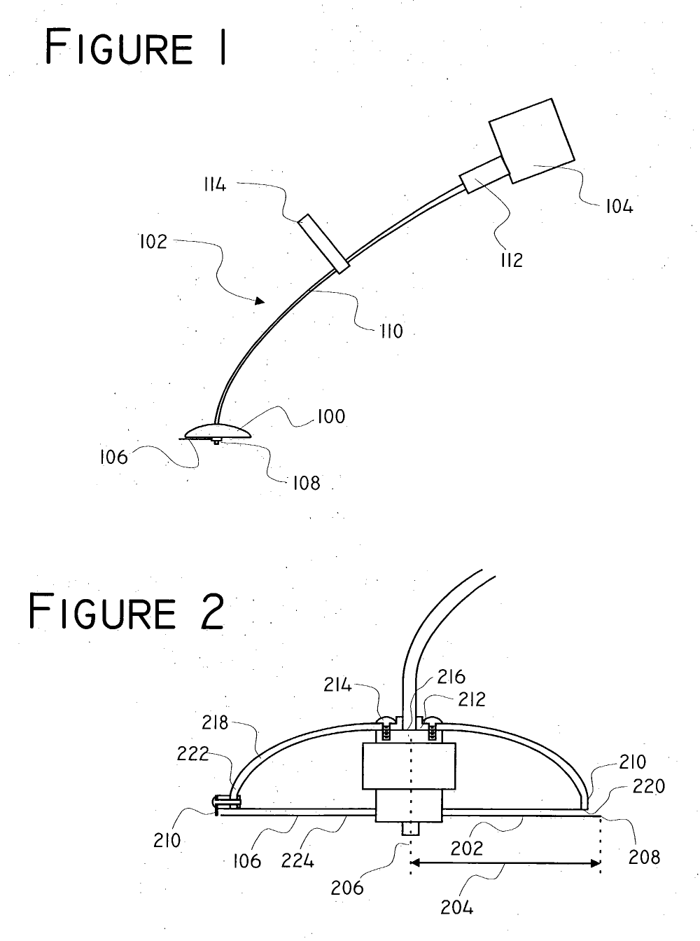

As shown in FIG. 2, the guard 100 of the present invention may be mounted to extend from the shaft 110 or center assembly 108. The motion of the cutting element 106 describes a plane 202, the outer extent of which is defined by the length 204 of the cutting element 106 between a center of rotation 206 and a distal end 208 of the cutting element 106. The guard 100 may extend outward to form a circular perimeter 210 adjacent to the distal end 208 of the cutting element 106. The distal end 208 of the cutting element 106 preferably protrudes beyond the perimeter 208 of the guard 100. A cutter 210 may be provided to cause the cutting element 106 to be cut to the proper length as it passes the cutter 210. Such cutters 210 are typically used with lawn trimmers which utilize a monofilament type string as the cutting element. The guard 100 may have a surface 212 which may be screwed 214, riveted, or bolted to a flange 216 on the center assembly 108 of the lawn trimmer 102. Alternately, the guard 100 could be bonded or joined in any other fashion. Although the illustration shows the mounting to be located adjacent to the center of rotation 206 of the cutting element 106, the mounting could be off-set, although this could result in less than optimal performance of the guard.

The guard preferably extends a full 360 degrees around the plane 202 formed by the cutting circle. The guard 100 may include a downwardly extending curved side-wall 218, which terminates at a perimeter edge 220 lying just above the plane 202 formed by the cutting, element 106.

The guard 100 may preferably be constructed from a durable rigid material, such as steel, aluminum, rigid plastic or the like. The perimeter edge 220 of the guard preferably lies slightly inside of the periphery of the cutting circle and immediately above the plane formed by the cutting elements 106.

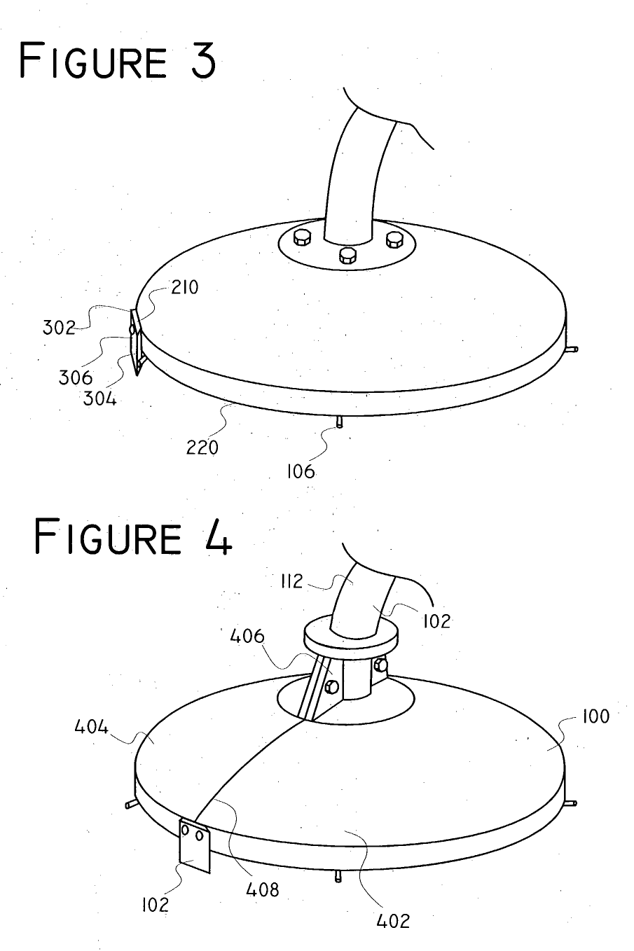

As shown in FIG. 3, the cutting element 106 may extend beyond the perimeter edge 220 of the guard 100, such that the cutting action of the elements 106 occurs to objects outside of the guard 100, reducing the interaction between objects and the mid-span portions of the cutting element (identified in FIG. 2 as 224). The cutter 210 may consist of a piece of metal 302 having a sharpened edge 304 along the outer surface 306 of the cutter 210. By placing the sharpened edge 304 on the outer surface 306, the sharpened edge 304 may be readily located to allow the cutting element 106 to extend past the perimeter 220 of the guard 100. In other embodiments, the cutter 210 may be adjustable or removable to control the length of the filament, or to allow use of longer chain, metal, plastic, or rigid cutting blades.

As shown in FIG. 4, the guard 100 may be formed from multiple pieces, to simplify attachment of the guard 100 to a trimmer 102. In FIG. 4, the guard is shown as being formed from two guard halves 402, 404. The guard halves 402, 404 may be symmetrical, such that only a single shape would need to be produced. The guard halves 402, 404 may be joined to each other at a flange 406 adjacent to the shaft 112 of a lawn trimmer 102, allowing easy installation of the guard 100 onto the shaft 112. The two perimeter halves 402, 404 of the guard 100 may be joined by cutters 210 placed across the joint 408 formed by the two halves 402, 404. Although an embodiment using two portions is shown, it will be readily apparent to those of ordinary skill in the art that the guard could be formed from more than two joinable portions, if so desired.

In testing of prototypes of the embodiments illustrated in FIGS. 1-4, surprising results were obtained. For example, using a 12 inch edge diameter circular guard of the present invention having a knife mounted approximately ½ inch outside the edge, two conventional gas-powered trimmers (John Deere model 25.S and Homelite Bandit SX-35) exhibited improved cutting at lower motor speeds, with noticeably less load on the engine. The trimmers were factory stock, having no other alterations other than removal of the factory guard and installation of the guard of the present invention.

The present invention may also allows improved operator efficiency. Using the guard of the present invention, an operator can stand in one spot and move the trimmer head around a tree trunk or other object rather than being required to point the trimmer at the object to enable cutting. This feature is especially beneficial along steep slopes and in stream beds, since it allows the operator to cut anywhere within his reach without having to traverse unsafe terrain to lead the trimmer head. With conventional guards having only partial guard coverage of the cutting circle, the operator must lead the trimmer and keep the trimmer head in front of him at all times to avoid flying debris.

The present invention may, of course, be carried out in other specific ways than those herein set forth without departing from the spirit and essential characteristics of the invention. The present embodiments are, therefore, to be considered in all respects as illustrative and not restrictive, and all changes coming within the meaning and equivalency range of this disclosure are intended to be embraced therein.

We claim:

1) A guard for a flexible element cutting device having at least one cutting element traveling in a circular plane, the cutting element having a length, a center of rotation, and a distal end, the guard comprising a guard portion and a perimeter edge, the perimeter edge forming a continuous circular edge above the circular plane of travel of the cutting element at a radius less than the length of the cutting element, said guard portion extending from said perimeter edge to adjacent said center of rotation.

2) A guard for a flexible element cutting device according to claim 1, wherein said radius is between about 80% and 95% of the length of the cutting element.

3) A guard for a flexible element cutting device according to claim 1, wherein said perimeter edge is spaced apart from said circular plane between about ⅛″ and ⅜″.

4) A guard for a flexible element cutting device according to claim 1, wherein said guard portion forms an arcuate circle of revolution.

5) A guard for a flexible element cutting device according to claim 1, further comprising a mounting feature, said mounting feature mounting said guard portion to a flexible element cutting device.

6) A guard for a flexible element cutting device according to claim 1, further comprising at least one cutter attached to said guard portion, said cutter being located at a radius greater than the radius of the perimeter edge and extending into the circular plane of travel of the at least one cutting element.

7) A guard for a flexible element cutting device having a center assembly and a rotating element, said guard comprising:
a perimeter wall, said perimeter wall forming a cylindrical wall above a cutting plane formed by the rotating cutting element;
a cover, said cover extending from said perimeter wall to a location adjacent to said center shaft;
a cover mount, said cover mount connecting said cover to said center assembly; and
at least one flexible element cutter, said flexible element cutter offset from said perimeter wall and extending into said cutting plane formed by the rotating cutting element.

8) A guard for a flexible element cutting device according to claim 7, wherein said flexible cutting element has a length extending from a center of rotation to a distal end, said perimeter wall forming a cylindrical wall at a radius about the center of rotation of the cutting element, said radius being less than the length of the cutting element.

9) A guard for a flexible element cutting device according to claim 8, wherein said radius is between about 80% and 95% of the length of the cutting element.

10) A guard for a flexible element cutting device according to claim 7, wherein said perimeter wall is spaced about ⅛″ to ⅜″ above said cutting plane formed by the rotating cutting element.

11) A guard for a flexible element cutting device having a center assembly and a rotating element, said guard comprising a first guard half and a second guard half, said first guard half being engageable with said second guard half to form a perimeter wall and a cover, said perimeter wall forming a cylindrical wall above a cutting plane formed by the rotating cutting element; said cover extending from said perimeter wall to a location adjacent said center assembly.

12) A guard for a flexible element cutting device according to claim 11, wherein said first guard half and said second guard half when engaged further form a cover mount, said cover mount connecting said cover to said center assembly.

13) A guard for a flexible element cutting device according to claim 11, wherein said flexible cutting element has a length extending from a center of rotation to a distal end of said cutting element, said perimeter wall forming a cylindrical wall at a radius about the center of rotation of the cutting element, said radius being less than the length of the cutting element.

14) A guard for a flexible element cutting device according to claim 13, wherein said radius is between about 80% and 95% of the length of the cutting element.

15) A guard for a flexible element cutting device according to claim 11, wherein said perimeter wall is spaced about ⅛″ to ⅜ above said cutting plane formed by the rotating cutting element.

16) A guard for a flexible element cutting device having a center assembly and a rotating element, said guard comprising a plurality of guard portions, said plurality of guard portions being engageable with each other to form a perimeter wall and a cover, said perimeter wall forming a cylindrical wall above a cutting plane formed by the rotating cutting element; said cover extending from said perimeter wall to a location adjacent said center assembly.

17) A guard for a flexible element cutting device according to claim 16, wherein said plurality of guard portions when engaged further form a cover mount, said cover mount connecting said cover to said center assembly.

18) A guard for a flexible element cutting device according to claim 16, wherein said flexible cutting element has a length extending from a center of rotation to a distal end of said cutting element, said perimeter wall forming a cylindrical wall at a radius about the center of rotation of the cutting element, said radius being less than the length of the cutting element.

19) A guard for a flexible element cutting device according to claim 18, wherein said radius is between about 80% and 95% of the length of the cutting element.

20) A guard for a flexible element cutting device according to claim 16, wherein said perimeter wall is spaced about ⅛″ to ⅜″ above said cutting plane formed by the rotating cutting element.
